(19) United States
(12) Patent Application Publication
(10) Pub. No.: US 2018/0142862 A1
(43) Pub. Date: May 24, 2018

(54) LAMPSHADE LOUVRE SYSTEM

(71) Applicant: Arnold Lee Hufstetler, III, Wellington, FL (US)

(72) Inventor: Arnold Lee Hufstetler, III, Wellington, FL (US)

(21) Appl. No.: 15/359,080

(22) Filed: Nov. 22, 2016

(51) Int. Cl. F21V 1/02; F21V 9/16; F21S 6/00; F21S 8/06

(52) U.S. Cl. CPC F21V 1/02; F21S 8/063; F21S 6/005; F21V 9/16

(57) ABSTRACT

A louvre system for a conical lampshade includes three or more separate rings of varying inner diameter. The rings are structured to be placed over the top of the lampshade so that they become seated on an exterior of the lampshade in a horizontal position and at vertically spaced intervals to diffuse light and enhance the appearance of the lampshade. A method of the invention is directed to enhancing the appearance and light diffusing characteristics of a conical lampshade including the steps of: determining multiple ring positions on the lampshade at vertically spaced intervals; determining the exterior diameter of the lampshade at each ring position; providing at least three rings having inner diameters corresponding to the ring position diameters; and dropping the rings over the top of the lampshade in an order of largest to smallest inner ring diameter so that the rings become seated at the ring positions.

### BACKGROUND OF THE INVENTION

### Field of the Invention

The present invention relates to a system for modifying a conical lampshade and, more particularly, to a system and method for diffusing light for conical lampshades that includes three or more separate rings of diminishing sizes that are placed on the exterior of the lampshade in a horizontal orientation and in a vertically spaced arrangement.

### Discussion of the Related Art

Lampshades are well-known and are used extensively on many types of light fixtures (e.g., floor lamps, table lamps, and ceiling suspended fixtures) for the purposes of softening the light emitted from the one or more bulbs of the light fixture and providing an ornamental appearance to the light fixture that may lend to the overall decor of a room. A typical lampshade has a conical shape with a smallest diameter at the top and a largest diameter at the bottom. While lampshades do serve the above-noted purposes, the typical conical lampshade is subtle in appearance and often goes unnoticed. Moreover, the light diffusing properties of a conical lampshade are minimal and provide only a limited decorative lighting effect.

Accordingly, there remains a need for a system and method that improves the ornamental appearance and light diffusing properties of a conical lampshade. More particularly, there is a need for a louvre system for conical lampshades that provides a unique architectural design and an enhanced decorative lighting effect by diffusing light between spaced rings.

### SUMMARY OF THE INVENTION

The present invention is directed to a louvre system for conical lampshades. The louvre system includes three or more separate rings of varying inner diameter. The rings are structured to be placed over the top of the lampshade so that they become seated on an exterior of the lampshade in a horizontal position and at vertically spaced tiers to diffuse light and enhance the appearance of the lampshade. A method of the invention is directed to enhancing the appearance and light diffusing characteristics of a conical lampshade. The method includes the steps of: determining multiple ring positions on the lampshade at vertically spaced intervals according to a desired arrangement; determining the exterior diameter of the lampshade at each ring position; providing at least three rings having inner diameters corresponding to the ring position diameters; and dropping the rings over the top of the lampshade in an order of largest to smallest inner ring diameter so that the rings become seated at the ring positions on the lampshade.

### Objects and Advantages of the Invention

Considering the forgoing, it is a primary object of the present invention to provide a system and method for conical lampshades that diffuses light and enhances the overall architectural appearance of the light fixture.

It is a further object of the present invention to provide a louvre system for conical lampshades that includes a plurality of rings of diminishing size that are structured for placement on the lampshade so that the individual rings become seated and positioned in a horizontal orientation and in a vertically spaced, parallel arrangement.

It is still a further object of the present invention to provide a louvre system for conical lampshades that includes a plurality of separate rings of a diminishing inner diameter from bottom to top, and wherein the rings can be held in a stacked array in progressively decreasing order of inner diameter size, with the largest inner diameter on the bottom and the smallest inner diameter on the top, and dropped over the top of a conical lampshade so that the plurality of rings become seated in a horizontal orientation and in a vertically spaced parallel arrangement.

It is still a further object of the present invention to provide a louvre system for conical lampshades that includes a plurality of rings which, when placed on a conical lampshade, have the visual effect of adding more depth to the lampshade, while also enhancing the light diffusing properties of the lampshade.

It is still a further object of the present invention to provide a louvre system for conical lampshades that includes a plurality of rings which, when placed on the exterior of the lampshade, make the lampshade appear larger.

It is yet a further object of the present invention to provide a louvre system for conical lampshades that includes a plurality of rings that can be easily manufactured of any light composite material.

It is still a further object of the present invention to provide a louvre system for conical lampshades that includes a plurality of rings made of wood, such as balsa.

It is still a further object of the present invention to provide a louvre system for conical lampshades that includes a plurality of rings made of a phosphorescent plastic that can absorb light to thereby present a plurality of glowing rings on the lampshade when the light fixture is off.

It is yet a further object of the present invention to provide a louvre system for conical lampshades that includes a plurality of rings that can be completely collapsed and conveniently packaged within a small rectangular box.

It is still a further object of the present invention to provide a louvre system for conical lampshades that includes a plurality of separate rings, and wherein the louvre system is easily installed on any conical lampshade of suitable size by the consumer with no special skills or tools required.

It is yet a further object of the present invention to provide a louvre system for conical lampshades that includes a plurality of separate rings, and wherein the louvre system can be installed on floor lamps, table lamps, or ceiling light fixtures having conical lampshades.

These and other objects and advantages of the present invention are more readily apparent with reference to the following detailed description taken in conjunction with the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is an isolated side elevational view of a conical lampshade on a floor lamp or table lamp shown with the louvre system of the present invention installed thereon;

FIG. 2 is an isolated side elevational view of a ceiling mounted light fixture having a conical lampshade and shown with the louvre system of the present invention installed thereon;

FIG. 3 is a top plan view of an individual ring of the louvre system showing an inner diameter of the ring, as indicated by the arrows;

FIG. 4 is a side elevational view, in partial cross-section, showing three separate rings of the louvre system of the present invention installed on a conical lampshade and positioned at spaced ring positions of progressively increasing diameter from the top position to the bottom position;

FIG. 5 is a two dimensional diagram of a conical lampshade configuration, shown as a right trapezoidal shape, and divided into two right triangles on opposite sides of a central square or rectangular area, and demonstrating use of the measured length of the linear sides of the right triangle and rectangular shapes for purposes of determining the diameters of the multiple ring positions on the lampshade, and thus the corresponding inner diameters of the plurality of rings; and

FIG. 6 is an isolated view of a right triangle taken from the right trapezoidal shape in FIG. 5 for purposes of demonstrating the method of determining the diameters at the multiple ring positions on the lampshade, and thus the corresponding inner diameters of the plurality of rings.

Like reference numerals refer to like parts throughout the several views of the drawings.

### DETAILED DESCRIPTION OF THE PREFERRED EMBODIMENTS

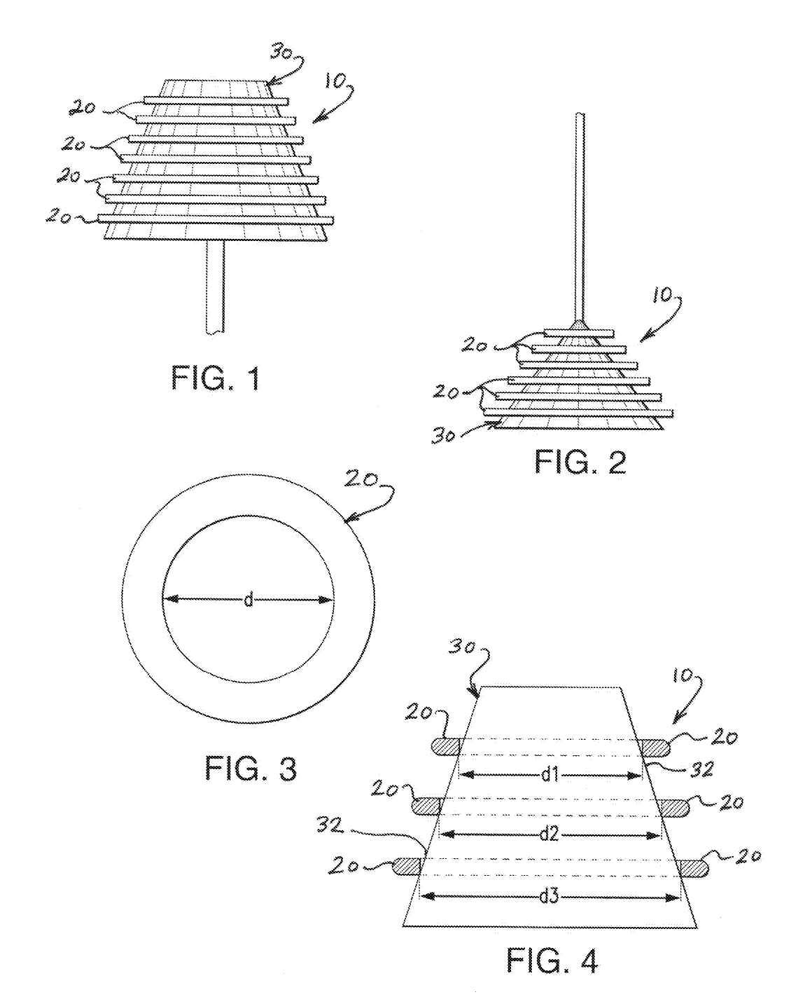

Referring initially to FIGS. 1-4, the louvre system for a conical lampshade is shown and is generally indicated as 10. As seen in FIGS. 1, 2 and 4, the louvre system 10 includes a plurality of rings 20 that are placed on the exterior of a conical lampshade. FIG. 1 illustrates the louvre system 10, including seven rings 20 placed on the conical lampshade 30 of a floor lamp or table lamp. FIG. 2 shows the louvre system 10 including six rings 20 fitted on the exterior of a conical lampshade 30 of a ceiling mounted light fixture. In a preferred embodiment of the invention, the louvre system 10 includes at least three rings and as many as twelve rings that are placed on the conical lampshade.

As seen in FIG. 3, each ring 20 has an inner diameter (d) that is particularly sized to cause the ring 20 to be seated against the exterior surface 32 of the conical lampshade 30 at a desired ring position. The plurality of rings 20 are each of a different inner diameter size so that when the rings 20 are placed on the lampshade 30, they are each seated at a different ring position, as seen in FIGS. 1, 2 and 4. For instance, referring to FIG. 4, the ring diameters (d1-d3) are progressively increased from the uppermost ring to the lowermost ring so that each ring 20 becomes seated on the exterior of the lampshade 30 at a different ring position. In one embodiment, the ring positions may be equally spaced apart, as seen in FIGS. 1, 2 and 4 so that the rings 20 are equally spaced with the same size gap between each ring. Alternatively, the spacing between the rings 20 can be different to create a desired effect. Moreover, the user may choose to remove some of the rings 20 to create larger gaps and smaller gaps between successively positioned rings.

In one embodiment, the rings 20 are made of a wood material, such as balsa. In another embodiment, the rings 20 are made of a phosphorescent plastic which has the ability to absorb light and then emit light as a glowing illumination over a period of several hours. In this embodiment, the louvre system 10 presents a plurality of glowing rings 20 on the lampshade 30 when the light fixture is turned off. Other suitable light composite materials for the manufacture of the rings 20 are fully contemplated within the spirit and scope of the invention.

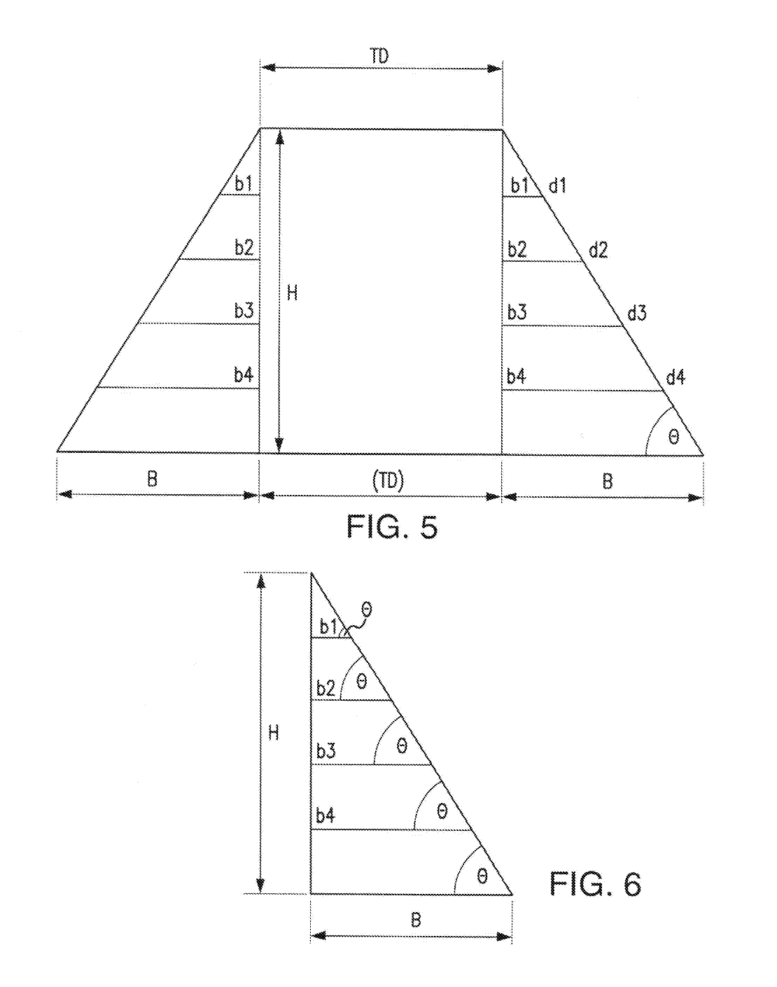

Referring to FIGS. 5 and 6, a method for determining the lampshade diameter at each ring position, and the corresponding inner ring diameters for desired ring positions is demonstrated. Referring to FIG. 5, the two dimensional diagrammatic configuration of a conical lampshade is shown and is a right trapezoidal shape. This right trapezoidal shape can be broken up into three geometric configurations, namely two right triangles on opposite sides of a central rectangle or square configuration. The length of the base (B) of each right triangle can easily be determined by subtracting the length of the top of the right trapezoid from the length of the base of the right trapezoid and dividing the difference by two. Since the top diameter (TD) of the lampshade can be easily measured and the bottom diameter of the lampshade can be easily measured, the base of either triangle is equal to the bottom diameter of the lampshade minus the top diameter (TD) and then the difference divided by two. Knowing the base of either right triangle and the hypotenuse of the triangle, which is equal to the measured slant length of the lampshade, the bottom angle θ of the lampshade can be determined.

Since the height (H) of the right triangle can be easily measured by measuring vertically from the top to the bottom of the lampshade, the hypotenuse can be determined by measuring the slant length of the conical lampshade (i.e., the hypotenuse equals the measured slant length of the lampshade), and the base of each right triangle can be easily determined as explained above, the bottom angle θ of the lampshade at each right triangle can be determined by calculating either the sine or cosine of that angle.

$$Sine θ = \frac{Opposite}{hypotenuse} OR \frac{Height}{Slant Length}$$

$$Cosine θ = \frac{adjacent}{hypotenuse} OR \frac{Base}{Slant Length}$$

Next, since the bottom angle θ, which can be calculated as set forth above, is the same at each of the smaller right triangles created at each ring position (d1-d4), as shown in FIG. 6, the base (b1-b4) of each of the smaller right triangles can be calculated by simply knowing the desired ring position and the measured distance from the top of the lampshade down the slant of the lampshade to each desired ring position, thus providing the length of the hypotenuse of each of the smaller triangles.

The base (b1-b4) of each of those smaller right triangles can be determined using the formula:

$$Cosine θ = \frac{adjacent ( base of smaller triangle )}{hypotenuse ( slant length of smaller right triangle )}$$

The calculation of each lampshade diameter (i.e., desired ring position) at d1-d4 is performed using the following equations:

d1=(2×b1)+TD(Top Diameter of the lampshade)

d2=(2×b2)+TD

d3=(2×b3)+TD

d4=(2×b4)+TD

These ring position diameters (d1-d4) on the lampshade 30 correspond with the needed inner diameters of each of the rings 20 for the rings to be seated at the desired ring positions on the lampshade. Accordingly, the lowermost ring will need a diameter equal to d4 while the next successive rings above the lowermost ring will require an inner diameter equal to d3, d2 and d1, respectively, in order for the rings 20 to become seated on the exterior of the lampshade 30 at the desired ring positions.

According to the method of the present invention, the plurality of rings 20, each having a different diameter (e.g., d1-d4), are held in a stacked arrangement in the order of largest diameter on the bottom to the smallest diameter at the top of the stack. The stack of rings can then be held over the top of the lampshade 30 and centered so that when dropped, the rings 20 pass over the top of the lampshade 30 and become seated at the desired ring positions, as seen in FIGS. 1, 2 and 4.

While the present invention has been shown and described in accordance with several preferred and practical embodiments, it is recognized that departures from the instant disclosure are fully contemplated within the spirit and scope of the present invention which is not to be limited except as defined in the following claims.

What is claimed is:

1. A louvre system for a conical lampshade on a light fixture, the louvre system comprising:
at least three separate rings each having an inner diameter, and the inner diameter of the rings progressively increasing from a smallest one of the rings to a largest one of the rings, and the inner diameter of each one of the rings being greater than a top diameter of the conical lampshade and less than a bottom diameter of the conical lampshade, and the at least three separate rings being structured and disposed for placement over a top of the conical lampshade so that the at least three separate rings become seated in a generally horizontal position on an exterior of the lampshade and at vertically spaced tiers with the smallest one of the rings seated at a highest position on the lampshade and the largest one of the rings seated at a lowest position on the lampshade; and
the at least three separate rings being further structured and disposed for diffusing light emitted from the light fixture when the rings are at the seated positions on the lampshade and the light fixture is on.

2. The louvre system as recited in claim 1 wherein the at least three separate rings each have an outer diameter, and the outer diameter of the at least separate rings progressively increasing from the smallest one of the rings to the largest one of the rings.

3. The louvre system as recited in claim 1 wherein the at least three separate rings are made of a light composite material.

4. The louvre system as recited in claim 3 wherein the light composite material is wood.

5. The louvre system as recited in claim 4 wherein the light composite material is balsa wood.

6. The louvre system as recited in claim 3 wherein the light composite material is a plastic composition.

7. The louvre system as recited in claim 6 wherein the light composite material includes a phosphorescent composition.

8. A method for enhancing the diffusing characteristics of a conical lampshade on a light fixture comprising the steps of:
providing at least three separate rings each having an inner diameter, and the inner diameter of the rings progressively increasing from a smallest one of the rings to a largest one of the rings, and the inner diameter of each one of the rings being greater than a top diameter of the conical lampshade and less than a bottom diameter of the conical lampshade, and the at least three separate rings being structured and disposed for placement over a top of the conical lampshade so that the at least three separate rings become seated in a generally horizontal position on an exterior of the lampshade and at vertically spaced tiers with the smallest one of the rings seated at a highest position on the lampshade and the largest one of the rings seated at a lowest position on the lampshade;
determining desired ring positions of the at least three separate rings on the exterior of the lampshade;
calculating a diameter of the lampshade at each of the desired ring positions;
providing the at least three separate rings having inner diameters that correspond with the calculated lampshade diameters at the determined ring positions; and
placing the at least three separate rings on the lampshade so that the at least three separate rings become seated at the desired ring positions.

9. The method as recited in claim 8 further comprising the steps of:
arranging the at least three separate rings in a stacked arrangement in an order of largest to smallest inner ring diameter with the largest one of the rings on the bottom of the stacked arrangement and the smallest one of the rings on the top of the stacked arrangement;
holding the stacked arrangement of the at least three separate rings over a top of the lampshade; and
releasing the stacked arrangement of the at least three separate rings and allowing the at least three separate rings to drop over the top of the lampshade and become seated at the determined ring positions.
